(19) United States
(12) Patent Application Publication
(10) Pub. No.: US 2020/0341750 A1
(43) Pub. Date: Oct. 29, 2020

(54) METHOD OF UPGRADING INVERTER SOFTWARE, SYSTEM AND ELECTRONIC DEVICE USING THE SAME

(71) Applicant: Delta Electronics (Shanghai) CO., LTD, Shanghai (CN)

(72) Inventors: Shen CHEN, Shanghai (CN); Feidong XU, Shanghai (CN); Xuancai ZHU, Shanghai (CN)

(73) Assignee: Delta Electronics (Shanghai) CO., LTD, Shanghai (CN)

(21) Appl. No.: 16/924,251

(22) Filed: Jul. 9, 2020

Related U.S. Application Data
(63) Continuation-in-part of application No. 16/234,825, filed on Dec. 28, 2018, now abandoned.

(30) Foreign Application Priority Data
Jan. 3, 2018 (CN) 201810004154.6

(51) Int. Cl. G06F 8/658; H04L 29/08; G06F 8/71; H02S 40/32

(52) U.S. Cl. CPC G06F 8/658; H04L 67/1095; H02S 40/32; H04L 67/34; G06F 8/71

(57) ABSTRACT

A method of upgrading inverter software comprises: embedding a software upgrade package for software to be upgraded into an application package, and uploading the application package to a server; obtaining the application package from the server through a terminal and sending the application package to an inverter, wherein the terminal and the inverter are connected through a wireless communication; in an operating cycle, determining by the inverter whether current time is within a predetermined time window, and if the current time is within the predetermined time window, performing a next operation, and if the current time is not within the predetermined time window, entering a next operating cycle; obtaining version information of the software of the inverter to be upgraded; and if the version information of the software to be upgraded is lower than that of the application package, performing an upgrade operation.

### CROSS-REFERENCE TO RELATED APPLICATIONS

This application is a CIP of U.S. application Ser. No. 16/234,825 filed on Dec. 28, 2018, based upon and claims priority to Chinese Patent Application No. 201810004154.6, filed on Jan. 3, 2018, the entire content of which is hereby incorporated by reference for all purposes.

### TECHNICAL FIELD

The present disclosure relates to the field of data communication technologies, and particularly to a method of upgrading inverter software, a system and an electronic device using the method.

### BACKGROUND

A photovoltaic inverter can convert direct current (DC) power into alternating current (AC) power, which is the core device of a photovoltaic power generation system. Due to some regulations, customer requirements or product maintenance requirements, photovoltaic inverters are required to be upgraded at times. At present, the existing software upgrade process for a photovoltaic inverter mainly relies on wired mode or gateway-based wireless mode, but these upgrade methods are not highly automatized, and require technicians to participate in the upgrade process.

In view of the above defect, it needs a method of upgrading inverter software, a system and an electronic device using the method to realize automatic upgrade of photovoltaic inverter software and simplify the upgrade operation.

It shall be noted that the above information disclosed in this background section is only for enhancement of understanding of the background of the present disclosure, therefore it may contain information that does not form the prior art that is already known to the ordinary skilled in the art.

### SUMMARY

An object of the present disclosure is to provide a method of upgrading inverter software, a system and an electronic device using the method, so as to overcome, at least to a certain extent, one or more problems caused by limitation and defects of related technologies.

According to a first aspect of the present disclosure, a method of upgrading inverter software is provided, including:

embedding a software upgrade package for software to be upgraded into an application package, and uploading the application package to a server;

obtaining the application package from the server through a terminal and sending the application package to an inverter, wherein the terminal and the inverter are connected through a wireless communication;

in an operating cycle, determining by the inverter whether current time is within a predetermined time window, and if the current time is within the predetermined time window, performing a next operation, and if the current time is not within the predetermined time window, entering a next operating cycle;

obtaining version information of the software of the inverter to be upgraded;

comparing the version information of the software of the inverter to be upgraded with version information of the software upgrade package in the application package; and

if a comparison result is that the version information of the software to be upgraded is lower than the version information of the software upgrade package in the application package, using the software upgrade package for the inverter to perform an upgrade operation.

According to a second aspect of the present disclosure, a system of upgrading inverter software is provided, including a server, a terminal and an inverter, wherein the inverter is deployed with software to be upgraded, and wherein

the server, configured to receive an application package and send the application package, wherein a software upgrade package for software to be upgraded is embedded into the application package;

the terminal, configured to obtain the application package from the server and send the application package; and

the inverter, configured to receive the application package sent by the terminal through a wireless communication, and, in an operating cycle, determine whether current time is within a predetermined time window, and if the current time is within the predetermined time window, perform a next operation, and if the current time is not within the predetermined time window, enter a next operating cycle; and further configured to obtain version information of the software of the inverter to be upgraded, and compare the version information of the software of the inverter to be upgraded with version information of the software upgrade package in the application package; and if a comparison result is that the version information of the software to be upgraded is lower than the version information of the software upgrade package in the application package, using the software upgrade package for the inverter to perform an upgrade operation.

According to a third aspect of the present disclosure, an electronic device is provided, embedded in the inverter in the system of upgrading inverter software according to any of the above aspect, including:

the inverter system controller; and

a memory, configured to store executable instructions for the inverter system controller and the software upgrade package, wherein

the inverter system controller is configured to execute the executable instructions to cooperate with the inverter to perform the wireless communication.

In a technical solution provided by some embodiments of the present disclosure, a software upgrade package for software to be upgraded is embedded into an application package and uploaded the application package to a server. The application package is obtained from the server through a terminal. The inverter compares version information of the software of the inverter to be upgraded with version information of the software upgrade package. When the version information of the software to be upgraded is lower than the version information of the software upgrade package, the software upgrade package is used for the inverter to perform an upgrade operation. On the one hand, the present disclosure realizes a solution for upgrading an inverter through a terminal, and the upgrade process is performed automatically without manual intervention; on the other hand, since the upgrade process does not require manual intervention, human mistakes can be avoided, and execution efficiency has been greatly increased.

It should be understood that the above general description and the detailed description below are merely exemplary and explanatory, and do not limit the present disclosure.

### BRIEF DESCRIPTION OF THE DRAWINGS

The accompanying drawings herein, which are incorporated in and constitute a part of this specification, illustrate embodiments consistent with the present disclosure, and, together with the description, serve to explain the principles of the present disclosure. Apparently, the accompanying drawings in the following description show merely some embodiments of the present disclosure, so the ordinary skilled in the art may further derive other drawings from these accompanying drawings without creative efforts.

FIG. 1 is a system block diagram schematically illustrating the inverter software upgrade according to prior art;

FIG. 2 is a flow chart schematically illustrating a method of upgrading inverter software according to an exemplary embodiment of the present disclosure;

FIG. 3 is a block diagram schematically illustrating the corresponding method of upgrading inverter software according to an exemplary embodiment of the present disclosure;

FIG. 4 is a block diagram schematically illustrating a system of upgrading inverter software according to an exemplary embodiment of the present disclosure;

FIG. 5 is a block diagram schematically illustrating an electronic device according to an exemplary embodiment of the present disclosure;

FIG. 6 is a block diagram schematically illustrating an inverter system controller according to an exemplary embodiment of the present disclosure;

FIG. 7 is a flow chart schematically illustrating sub-steps of upgrade operation within an inverter according to an exemplary embodiment of the present disclosure; and

FIG. 8 is a schematic diagram illustrating a non-volatile storage medium according to an exemplary embodiment of the present disclosure.

### DETAILED DESCRIPTION

The exemplary embodiments will now be described more fully with reference to the accompanying drawings. However, the exemplary embodiments can be implemented in a variety of forms and should not be construed as limited to the embodiments set forth herein. Rather, the embodiments are provided so that the present disclosure will be thorough and complete and will fully convey the concepts of exemplary embodiments to those skilled in the art. The features, structures, or characteristics described may be combined in one or more embodiments in any suitable manner. In the following description, numerous specific details are provided to give a full understanding of the embodiments of the present disclosure. Those skilled in the art will recognize, however, that the technical solution of the present disclosure may be practiced without one or more of the specific details described, or that other methods, components, materials, etc., may be employed. In other instances, well-known technical solutions are not shown or described in detail to avoid obscuring aspects of the present disclosure.

In addition, the accompanying drawings are merely exemplary illustration of the present disclosure, and are not necessarily drawn to scale. The same reference numerals in the drawings denote the same or similar parts, and thus repeated description thereof will be omitted. Some block diagrams shown in the figures are functional entities and not necessarily to be corresponding to a physically or logically individual entities. These functional entities may be implemented in software form, or implemented in one or more hardware modules or integrated circuits, or implemented in different networks and/or processor apparatuses and/or microcontroller apparatuses.

The flowcharts shown in the figures are merely illustrative and not necessarily include all of the steps. For example, some steps may be decomposed, and some steps may be combined or partially merged, so the actual execution order may vary depending on the actual situation.

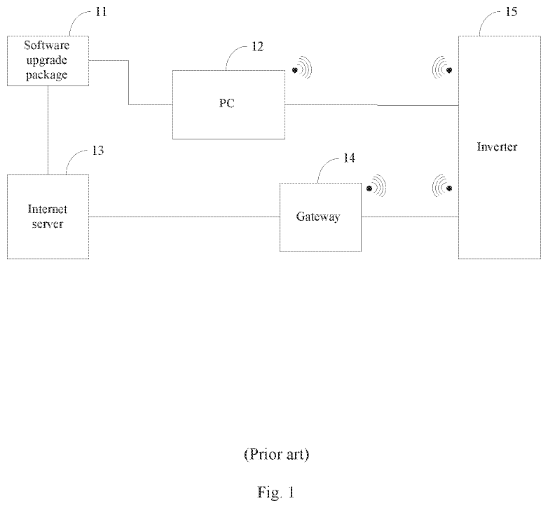

A photovoltaic inverter upgrade process of some existing technologies will be described with reference to FIG. 1. First, a developer can develop a software upgrade package (FW (Firmware) Package) 11 based on requirements; next, on the one hand, the upgrade can be performed through the PC 12, that is, the software upgrade package 11 is uploaded to the PC 12, and the PC 12 can establish a connection to the inverter 15 through for example a wire communication interface or a wireless manner. On the other hand, the upgrade can be performed through the gateway 14, that is, the software upgrade package 11 is uploaded to the Internet server 13, the Internet server 13 can establish a connection with the gateway 14 through the Ethernet, then the gateway 14 can establish a connection with the inverter 15 through for example a wire communication interface or a wireless manner. Consequently, in the case of upgrade through the PC terminal 12, operators in the filed can invoke a corresponding upgrade tool through the PC terminal 12 to start the software upgrade process of the inverter 15, and wait for the software upgrade to be completed. In the case of upgrade through the gateway 14, the operators in the background can invoke a corresponding upgrade tool in the background to start the software upgrade process of the inverter 15, and wait for the software upgrade to be completed.

It can be seen that the existing upgrade processes require manual intervention by operators (operators in the filed or in the background), and the process is complicated. Therefore, a new method of upgrading inverter software is provided in the exemplary embodiments of the present disclosure.

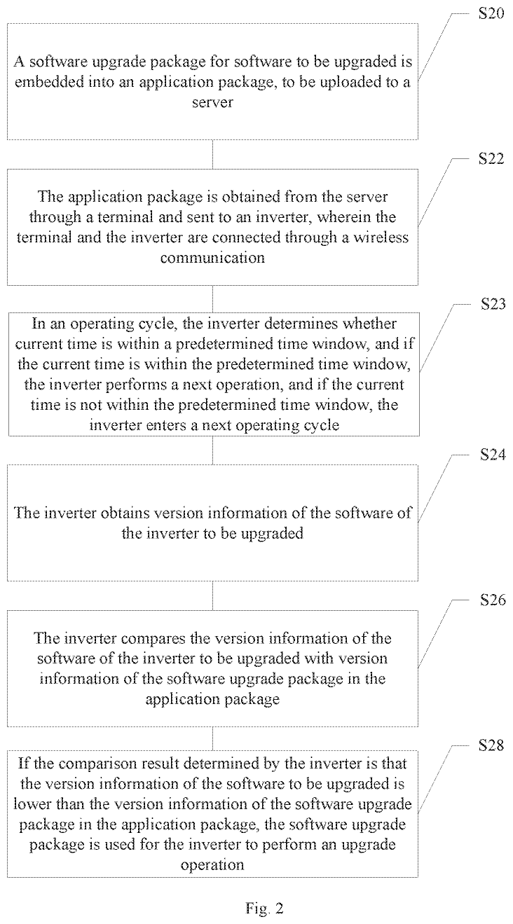

FIG. 2 is a flow chart of schematically illustrating a method of upgrading inverter software according to an exemplary embodiment of the present disclosure. Referring to FIG the method of upgrading inverter software may include the following steps S20-S28.

In step S20, a software upgrade package for software to be upgraded is embedded into an application package, to be uploaded to a server.

In step S22, the application package is obtained from the server through a terminal and sent to an inverter, wherein the terminal and the inverter are connected through a wireless communication.

In step S23, in an operating cycle, the inverter determines whether current time is within a predetermined time window, and if the current time is within the predetermined time window, the inverter performs a next operation, and if the current time is not within the predetermined time window, the inverter enters a next operating cycle.

In step S24, the inverter obtains version information of the software of the inverter to be upgraded.

In step S26, the inverter compares the version information of the software of the inverter to be upgraded with version information of the software upgrade package in the application package.

In step S28, if the comparison result determined by the inverter is that the version information of the software to be upgraded is lower than the version information of the software upgrade package in the application package, the software upgrade package is used for the inverter to perform an upgrade operation.

In the method of upgrading inverter software of the present disclosure, a software upgrade package is embedded into an application package to be uploaded to a server. The application package is obtained from the server through a terminal and sent to the inverter. The inverter compares the version information of the software of the inverter to be upgraded with the version information of the software upgrade package. When the version information of the software to be upgraded is lower than the version information of the software upgrade package, the software upgrade package is used for the inverter to perform an upgrade operation. On the one hand, the present disclosure realizes a solution for upgrading an inverter through a terminal, and the upgrade process is performed automatically without manual intervention. On the other hand, since the upgrade process does not require manual intervention, human mistakes can be avoided, and execution efficiency has been greatly increased.

Each step will be specifically explained below. In the step S20, a software upgrade package for software to be upgraded is embedded into an application package, to be uploaded to a server.

In an exemplary embodiment of the present disclosure, the software to be upgraded can be software required for the inverter to work. During the working operation of the inverter, due to some changes in regulations or rules, or changes of customer requirements, or the requirement for maintenance of the inverter itself, the software corresponding to the inverter should be upgraded.

Specifically, first, a developer can determine the upgrade requirement corresponding to the above upgrade reason, and subsequently, the developer can write a software upgrade package for the software to be upgrade according to the upgrade requirement. The disclosure does not specifically limit the process of writing the software upgrade package by the developer specifically and the content of the software upgrade package. The written software upgrade packages can be used to fix bugs of the software of the inverter or provide new functions for the inverter.

Next, the software upgrade package can be embedded into an application package. The application package may be received by the terminal and may be used to obtain information by the terminal. The specific type of the application package is not specifically limited in the present disclosure. In addition, the process of embedding the software upgrade package into the application package may be the same as the existing program embedding process, which will not be repeated herein.

Consequently, the application package in which the software upgrade package is embedded can be uploaded to the server on the development side. The server may be an application store server, or the server may be another server being capable of communicating with the terminal.

In addition, when the application package in which the software upgrade package is embedded is uploaded to the server, the application package can be encrypted, and only the terminal, which has obtained the password or specified by the encryption program, can obtain the application package from the server; and/or the software upgrade package can be encrypted during the process of embedding the software upgrade package into the application package, and only the specified terminal can extract the software upgrade package from the application package.

In the step S22, the application package is obtained from the server through the terminal and sent to the inverter, wherein the terminal and the inverter are connected through a wireless communication.

The terminal described in the present disclosure may refer to a mobile phone, but not limited thereto. The terminal may further include a portable terminal such as a tablet computer, and in addition, the terminal may further include a fixed terminal having a wireless communication function, which is not particularly limited in the exemplary embodiment.

In an exemplary embodiment of the present disclosure, when the server receives the application package in which the software upgrade package is embedded, the server can initiatively send the application package to the terminal.

In addition, after receiving the application package, the server may send a notification instruction to the terminal, the terminal may send an acquisition request to the server in response to the notification instruction, and the server may send the application package to the terminal in response to the acquisition request.

According to some other embodiments, the terminal may periodically monitor whether the server has an application package. After recognizing that the server has an application package, the terminal may send an acquisition request to the server, and the server sends the application package to the terminal in response to the acquisition request.

In an exemplary embodiment of the present disclosure, a wireless communication module can be configured in the inverter previously. Specifically, the inverter can he equipped with a Bluetooth unit. Bluetooth communication will be described below as a specific manner of the wireless communication of the present disclosure, however, it will be readily understood that the present disclosure may further use other short-distance wireless communication technology, such as the ZigBee.

In addition, in order to work properly with the Bluetooth unit, it is necessary to configure a corresponding Microcontroller Unit (MCU) as an inverter system controller. The MCU can be the original MCU of the inverter. However, it is possible to newly add another MCU to the inverter separately.

The terminal can send the application package to the inverter through the Bluetooth communication, wherein the software upgrade package for software to be upgraded is embedded into the application package. For example, the version information of the software to be upgraded is 5.2.

In step S23, in an operating cycle, the inverter determines whether current time is within a predetermined time window, and if the current time is within the predetermined time window, the inverter performs a next operation, and if the current time is not within the predetermined time window, the inverter enters a next operating cycle,

Since the steps in the method of upgrading inverter software of the present disclosure is performed in a cyclic manner, the item “an operating cycle” here refers to the time when the steps in the method of upgrading inverter software of the present disclosure are performed by one cycle.

The item “operation” mentioned here is to preform one certain step or a certain part of one certain step of the steps in the method of upgrading inverter software of the present disclosure.

The time window mentioned here is a time period, for example, it can be from 1 am to 4 am every day as a time window, or it can be from 1 am to 2 am every day as a time window, 3 am to 4 am as the next time window, or a time when the inverter is in a grid synchronization state or a standby state, but not limited thereto.

In step S24, the version information of the software of the inverter to be upgraded is obtained by the inverter.

In the present disclosure, in addition to that the terminal can obtain the version information of the software to be upgraded, the inverter system controller in the inverter can obtain the version information of the software to be upgraded by unpacking the application package as well.

In step S26, the inverter compares the version information of the software of the inverter to be upgraded with the version information of the software upgrade package in the application package.

In the present disclosure, in addition to that the terminal can compare the version information of the software of the inverter to be upgraded with the version information of the software upgrade package in the application package, the inverter system controller in the inverter can compare the version information of the software of the inverter to be upgraded with the version information of the software upgrade package in the application package as well. Specifically, since some version information may include character string other than numbers and has a long length, the version information may be compared by using a byte-by-byte comparison method.

In step S28, if the comparison result is that the version information of the software to be upgraded is lower than the version information of the software upgrade package in the application package, the software upgrade package is used for the inverter to perform the upgrade operation.

In an exemplary embodiment of the present disclosure, if the comparison result determined by the inverter is that the version information of the software to be upgraded is lower than the version information of the software upgrade package in the application upgrade package, the software upgrade package is used for the inverter to perform the upgrade operation. For example, the version information of the software to be upgraded obtained by the inverter is and the version information of the software upgrade package is 6.0, then the software upgrade package can be used for the inverter to perform the upgrade operation. In addition, an external memory can be configured in the inverter to store the software upgrade package, wherein the external memory can be the original memory of the inverter or another newly-added memory.

In an exemplary embodiment of the present disclosure, when the application package is sent to the inverter through the terminal, the terminal may execute a prompt event to inform the user to wait. The prompt event may be, for example, displaying a waiting prompt message on the screen of the mobile phone, and/or giving oft a voice prompt from the mobile phone, etc.

In addition, after obtaining the software upgrade package sent by the terminal, the inverter may detect the integrity of the software upgrade package, and only when it confirms that the software upgrade package is complete, the inverter performs the upgrade operation. If the inverter detects that the software upgrade package is incomplete, an alarm message is sent to the terminal through the Bluetooth unit, so that the terminal resends the application package. In addition, if, after a plurality of transmissions, the terminal still receives the alarm message sent by the inverter, the terminal can send feedback to the developer by way of mail or text message, so that the developer can determine the specific cause of the failure.

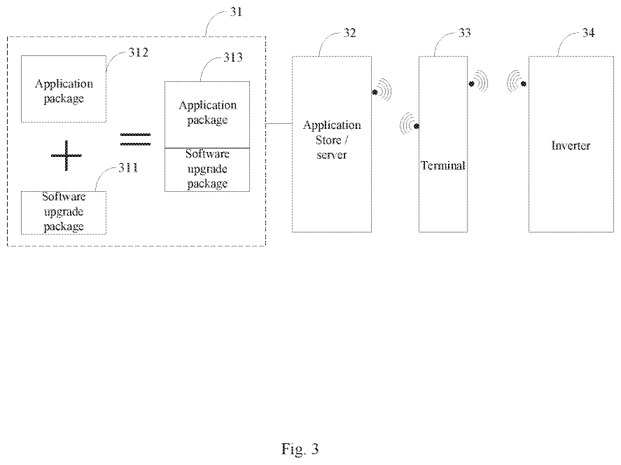

An example of the method of upgrading inverter software of the present disclosure will be described below with reference to FIG. 3. First, the software upgrade package 311 can be embedded into the application package 312 on the development side 31, to obtain the application package 313 in which the software upgrade package is embedded; then the application package 313 can be upload to the server 32, wherein the server 32 can be an application store server, or the server 32 may be other servers being capable of communicating with the terminal; subsequently, the server 32 can send the application package 313 to the mobile phone 33 through the mobile network; next, the mobile phone 33 can send the application package 313 to the inverter 34 through the Bluetooth communication.

In an operating cycle, the inverter 34 determines whether current time is within a predetermined time window, and if the current time is within the predetermined time window, the inverter performs a next operation, and if the current time is not within the predetermined time window, the inverter enters a next operating cycle.

The inverter 34 obtains the version information of the software to be upgraded of the inverter 34 and compares the version information of the software to be upgraded with the version information of the software upgrade package 311 in the application package 313.

When the comparison result determined by the inverter is that the version information of the software to be upgraded to be lower than the version information of the software upgrade package 311, the software upgrade package 311 is used for the inverter 34 to perform the upgrade operation.

After determining that the obtained software upgrade package is complete, the inverter 34 performs the upgrade operation based on the software upgrade package. Thereby, the entire process of the inverter software upgrade is completed.

It should be noted that, although the respective steps of the method of the present disclosure are described in a particular order in the drawings, this does not require or imply that the steps must be performed in this specific order, or that the desired result can be achieved only after all the steps shown are performed. Additionally or alternatively, certain steps may be omitted, and/or a plurality of steps may be combined into one step to perform, and/or one step may be decomposed into a plurality of steps to perform, and the like.

Further, a system of upgrading inverter software is provided in the exemplary embodiment.

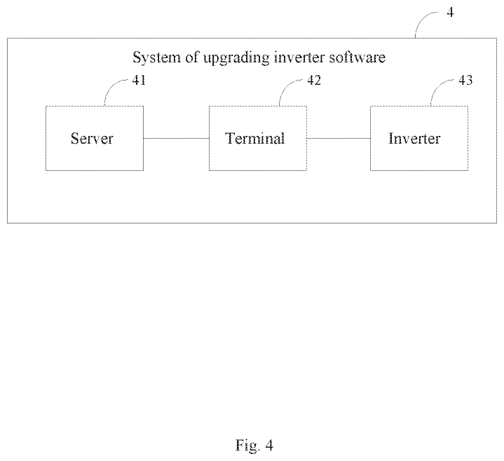

FIG. 4 is a block diagram schematically illustrating a system of upgrading inverter software according to an exemplary embodiment of the present disclosure. Referring to FIG. 4, the system of upgrading inverter software 4 according to an exemplary embodiment of the present disclosure may include a server 41, a terminal 42 and an inverter 43 deployed with software to be upgraded.

The server 41 is configured to receive an application package and send the application package, wherein a software upgrade package for software to be upgraded is embedded into the application package.

The terminal 42 is configured to acquire the application package from the server 41, and send through a wireless communication the application package to the inverter 43.

The inverter 43 is configured to receive the application package sent by the terminal 42 through the wireless communication, and in an operating cycle, determine whether current time is within a predetermined time window, and if the current time is within the predetermined time window, perform a next operation, and if the current time is not within the predetermined time window, enter a next operating cycle; and further configured to obtain version information of the software of the inverter 43 to be upgraded, and compare the version information of the software of the inverter to be upgraded with version information of the software upgrade package in the application package; and if a comparison result is that the version information of the software to be upgraded is lower than the version information of the software upgrade package in the application package, using the software upgrade package for the inverter to perform an upgrade operation.

According to the system of upgrading the inverter software of the present disclosure, on the one hand, the present disclosure realizes a solution for upgrading an inverter through a terminal, and the upgrade process is performed automatically without manual intervention; on the other hand, since the upgrade process does not require manual intervention, human mistakes can be avoided, and execution efficiency can be greatly increased.

According to an exemplary embodiment of the present disclosure, both the terminal and the inverter are equipped with a Bluetooth unit, and the wireless communication is the Bluetooth communication, to realize the solution for upgrading the inverter through a manner of the Bluetooth communication.

According to an exemplary embodiment of the present disclosure, the terminal is further configured to execute a prompt event to inform the user to wait when the application package is being sent to the inverter.

In the embodiment, by informing the user to wait, the conditions that the user leaves or shuts down the terminal when the transmission is not completed can be avoided, thereby the integrity of transmission of the software upgrade package can be ensured.

According to an exemplary embodiment of the present disclosure, after obtaining the software upgrade package, the inverter detects the integrity of the software upgrade package, and only when it confirms that the software upgrade package is complete, the inverter can perform the upgrade operation.

In the embodiment, a verification mechanism for the software upgrade package is provided to ensure that the software upgrade package can be completely transmitted to the inverter to perform the upgrade operation.

In the method of upgrading inverter software of the present disclosure, a time-dividing mechanism is provided. That is to say, the upgrade operation in the present disclosure is not real-time, but is designed with a time window When the time window has arrived, the next step of the upgrade operation is entered, otherwise the upgrade operation is waiting for a next operating cycle. If the upgrade operation cannot be completed within the current time window, it will continue in the next time window. The benefit of time-dividing is to ensure that the inverter performs the upgrade operation at proper time, so as to minimize the impact of the upgrade operation on the running of the inverter. The upgrade operation of the present disclosure is random, that is, when the software upgrade package is downloaded, the present disclosure performs the upgrade operation of the inverter in a condition without affecting the normal power generation. The time-dividing mechanism designed in the present disclosure automatically detects the working state of the inverter (including the maximum power tracking state, grid synchronization state, standby state, etc.), and chooses to perform the upgrade operation in a proper state of the inverter. For example, when the inverter is working in the maximum power tracking state, the upgrade operation is not performed, and when the inverter is in the grid synchronization state or the standby state, the upgrade operation is performed

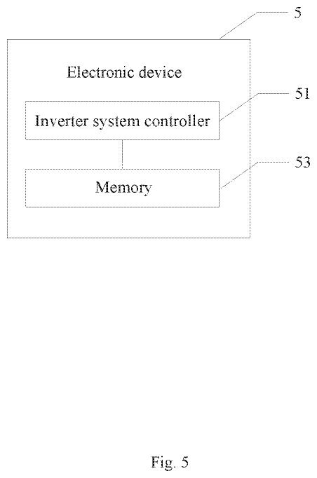

According to an exemplary embodiment of the present disclosure, an electronic device is further provided. The electronic device can be embedded into the inverter described above, or can be embedded into a plurality of inverters in a distribution manner. Referring to FIG. 5, the electronic device 5 may include an inverter system controller 51 and a memory 53, wherein the memory 53 is configured to store executable instructions for the inverter system controller 51 and the software upgrade package, and the inverter system controller 51 may be a microprocessor and is configured to execute the executable instructions to cooperate with the inverter to perform the wireless communication. Additionally, the memory 53 can include readable and writable media with volatile memory cells.

According to an exemplary embodiment of the present disclosure, the inverter may include one master inverter and a plurality of slave inverters, Correspondingly, the aforementioned inverter system controller 51 may include a master controller and a plurality of slave controllers, which are respectively provided in the corresponding inverters of the master inverter and the plurality of slave inverters, such arrangement is the aforementioned distribution manner, so as to control the master inverter and the plurality of slave inverters separately.

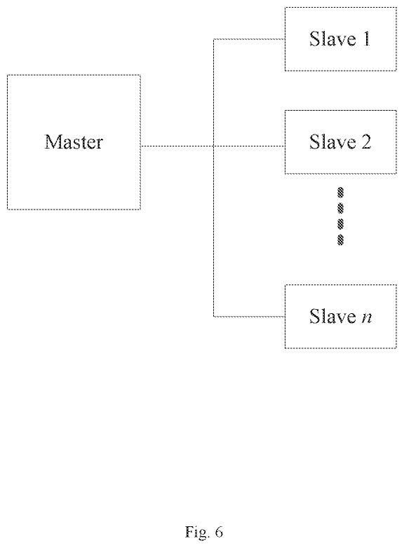

FIG. 6 is a block diagram schematically illustrating an inverter system controller according to an exemplary embodiment of the present disclosure. Referring to FIG. 6, the master controller is Master, and the plurality of slave controllers are Slave 1, Slave 2, . . . , Slave n. If there is only one inverter in the system, both the master controller and the slave controllers are microcontrollers installed in the inverter. If there are a plurality of inverters in the system, the master controller and the slave controllers may also be microcontrollers installed in the master inverter and n slave inverters, respectively.

The master controller may be connected with the slave controllers through a wired communication. The wired communication may be RS485 (a typical serial communication standard), UART (Universal Asynchronous Transceiver Transmitter), I2C (developed by Philips, a simple, bidirectional two-wire synchronous serial bus), SPI (serial peripheral interface) and other manners.

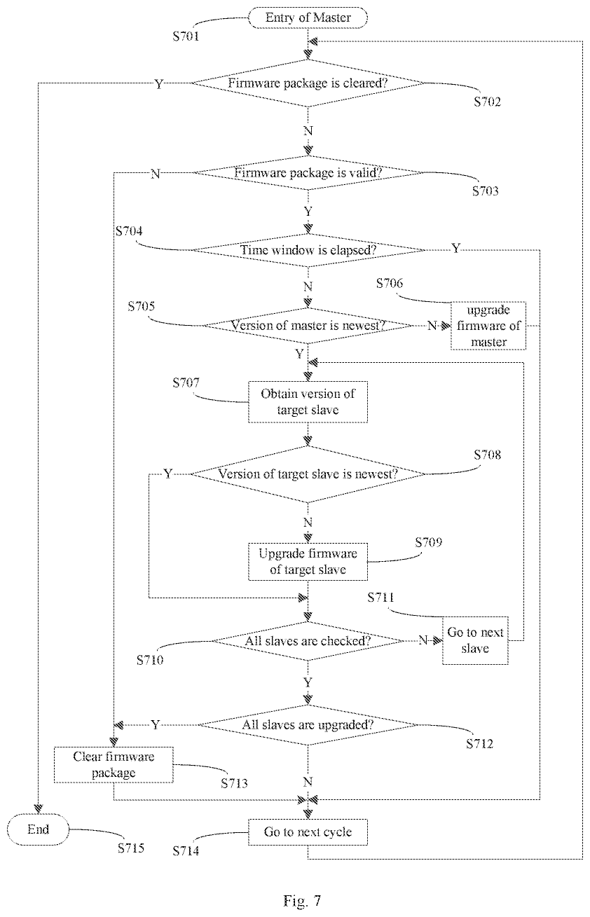

FIG. 7 is a flow chart schematically illustrating sub-steps of upgrade operation within an inverter according to an exemplary embodiment of the present disclosure. The flowchart of the sub-steps of upgrade operation within an inverter of FIG. 7 is a specific example of the steps S23-S28 of upgrade operation of the inverter of FIG. 2 under the control of the inverter system controller of FIG. 6, for implementing a part of function of the inverter of the present disclosure.

Referring to FIG. 7, the sub-steps of upgrade operation within the inverter of this exemplary embodiment include the following sub-steps:

S701. Entry of Master, that is, a sub-step of entering an upgrade operation of the master controller.

S702. Firmware package is cleared? that is, a sub-step of determining whether the software upgrade package has been cleared. If it has not been cleared, proceeding to the next sub-step, and if it has been cleared, going to a termination sub-step S715.

S703. Firmware package is valid? that is, a sub-step of determining whether the software upgrade package is valid, or, whether the software upgrade package is completely available. If it is valid, proceeding to the next sub-step, and if it is invalid, going to a clearing sub-step S713.

S704. Time window is elapsed? that is, a sub-step of determining whether current time is within a predetermined time window. If it is within the predetermined time window proceeding to the next sub-step, and if it is not within the predetermined time window, going to a first cycle sub-step S714, so as to enter the next operation cycle. That is, to realize the foregoing step S23, in an operating cycle, the inverter determines whether current time is within a predetermined time window, and if the current time is within the predetermined time window, the inverter performs a next operation, and if the current time is not within the predetermined time window, the inverter enters a next operating cycle.

S705. Version of master is newest? that is a sub-step of determining the version information of the master controller. If the version information of the master controller is already the latest, proceeding to the next sub-step, and if the version information of the master controller is not the latest, going to a upgrade sub-step S706. That is, to realize the foregoing step S24, the inverter obtains version information of the software of the inverter to be upgraded; and step S26, the inverter compares the version information of the software of the inverter to be upgraded with version information of the software upgrade package in the application package.

S706. Upgrade firmware of master, that is, a sub-step of upgrading the software of the master controller, and then going to the first cycle sub-step S714, so as to enter the next operating cycle. That is, to realize the foregoing step S28, if the comparison result determined by the inverter is that the version information of the software to be upgraded is lower than the version information of the software upgrade package in the application package, the software upgrade package is used for the inverter to perform an upgrade operation.

If there are slave controllers, the sub-steps of upgrade operation within the inverter may further include the following sub-steps similar to the sub-steps of upgrade operation of the master controller:

S707. Obtain version of target slave, that is, a sub-step of obtaining the software version information of a target slave controller (that is, a slave controller to be upgraded).

S708. Version of target slave is newest? that is, a sub-step of determining the version information of this target slave controller. If the version information of this target slave controller is not the latest, proceeding to the next sub-step, that is, a target slave controller software upgrade sub-step S709, and if the version information of the software upgrade package of this target slave controller is already the latest, skipping the target slave controller software upgrade sub-step S709.

S709. Upgrade firmware of target slave, that is, a sub-step of software upgrade of target slave controller. After sub-step S709 is performed, the upgrade operation goes to a sub-step S710 for determining upgrade status of slave controllers.

S710. All slaves are checked? that is, a sub-step of determining whether the version information of the all slave controllers to be upgraded in the inverter has been compared with the version information of the software upgrade package. If the version information of the software of all of the slave controllers to be upgraded in the inverter has been compared with the version information of the software upgrade package, proceeding to the next sub-step, and if not the version information of the software of all of the slave controllers to be upgraded in the inverter has been compared with the version information of the software upgrade package, going to a second cycle sub-step S711.

S711. Go to next slave, that is, a sub-step of going to a next target slave controller so as to start the software upgrade of the next target slave controller, and going to the sub-step of obtaining software version information of a target slave controller in the inverter.

S712. All slaves are upgraded? that is, a sub-step of determining whether the software of all of the slave controllers in the inverter has been upgraded. If not the software of all of the slave controllers in the inverter has been upgraded, going to first cycle sub-step S714, so as to enter the next operating cycle, and if the software of all of the slave controllers in the inverter has been upgraded, going to the clearing sub-step S713.

S713. Clear firmware package, that is, a sub-step of clearing software upgrade package. Since the use of the software upgrade package has been completed, and the software upgrade package is automatically cleared to avoid occupying storage space.

S714. Go to next cycle, that is, a sub-step of first cycle, for guiding the upgrade operation to the next operating cycle, so as to wait for the arrival of the next predetermined time window, and then perform the next inverter upgrade operation.

In other words, if not all the slave controllers in the inverter have already compared the version information, if not the version information of the software of all of the slave controllers to be upgraded in the inverter has been compared with the version information of the software upgrade package, going to a next slave controller to be upgraded in the inverter, and going to the step of obtaining the version information of the software of the said next slave controller to be upgraded in the inverter; and if the version information of the software of all of the slave controllers to be upgraded in the inverter has been compared with the version information of the software upgrade package, determining whether the software of all of the slave controllers in the inverter has been upgraded; and if not the software of all of the slave controllers in the inverter has been upgraded, entering the next operating cycle; if the software of all of the slave controllers in the inverter has been upgraded, clearing the application package.

S715. End, that is, a sub-step termination of the upgrade operation, for confirming that all inverters have been successfully upgraded, and all upgrade operations can be ended.

According to an exemplary embodiment of the present disclosure, a readable and writable storage medium is further provided, on which a program product is stored, being capable of implementing the above method of the present specification. In some possible implementations, the respective aspects of the present disclosure may further be realized in a form of a program product comprising program code, and when the program product runs on a terminal device, the program code is configured to cause the terminal device to perform the steps according to various exemplary embodiments of the present disclosure described in the “detailed description” section of the present specification.

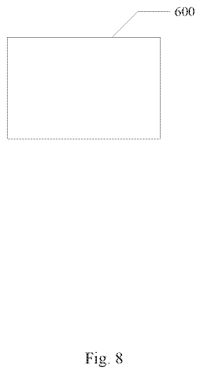

Referring to FIG. 8, which illustrates a program product 600 for implementing the above method according to an exemplary embodiment of the present disclosure, the program product 600 is a readable and writable medium and includes program code, and can run on a terminal device, such as a personal computer. However, the program product of the present disclosure is not limited thereto, and in this document, the readable and writable storage medium may be any tangible medium containing or storing a program that can be used by or in conjunction with an instruction execution system, apparatus or device.

The program product can take any combination of one or more readable and writable media. The readable and writable medium can be readable and writable signal medium or readable and writable storage medium. The readable and writable storage medium can be, for example, but not limited to, an electronic, magnetic, optical, electromagnetic, infrared, or semiconductor system, apparatus, or device, or any combination of the above. More specific examples (non-exhaustive lists) of readable and writable storage media include: electrical connections having one or more wires, hard disks, flash memories, optical fibers, optical storage devices, magnetic storage devices, or any suitable combination of the foregoing.

The readable and writable signal medium can include a data signal that is propagated in the baseband or as part of a carrier, in which the program code is carried. Such propagated data signals can take a variety of forms including, but not limited to, electromagnetic signals, optical signals, or any suitable combination of the foregoing. The readable and writable signal medium can be any readable and writable medium other than a readable and writable storage medium, which can transmit, propagate, or transport a program for use by or in connection with an instruction execution system, apparatus, or device.

Program code included on the readable and writable medium can be transmitted by using any suitable medium, including but not limited to wireless, wired, optical cable, RF, etc., or any suitable combination of the foregoing.

Program code for performing the operations of the present disclosure may be written in any combination of one or more programming languages, including an object oriented programming language such as Java, C++, etc., or including conventional procedural programming language such as the “C” language or a similar programming language. The program code can execute entirely on the user's computing device, partially on the user's device, as a standalone software package, partially on the user's computing device and partially on the remote computing device, or entirely on the remote computing device or a server. In the case of a remote computing device, the remote computing device can be connected to the user's computing device via any kind of network, including a local area network (LAN) or a wide area network (WAN), or can be connected to an external computing device (e.g., using an Internet service provider to connect via the Internet).

Through the description of the above embodiments, those skilled in the art will readily understand that the example embodiments described herein may be implemented by software or by software in combination with necessary hardware. Therefore, the technical solution according to an embodiment of the present disclosure may be embodied in a form of a software product, which may be stored in a non-volatile storage medium or on a network, including a plurality of instructions to cause a microprocessor, a server, a terminal device or a network device or the like performs a method according to an embodiment of the present disclosure.

Further, the above-described drawings are merely illustrative of the processes included in the method according to the exemplary embodiments of the present disclosure, and are not intended to be limiting. It is easy to understand that the processing shown in the above figures does not indicate or limit the chronological order of these processes. In addition, it is also easy to understand that these processes may be performed for example, synchronously or asynchronously in a plurality of modules.

It should be noted that, although several modules or units of equipment for action execution are mentioned in the detailed description above, such division is not mandatory. In fact, in accordance with the embodiments of the present disclosure, features and functions of two or more of the modules or units described above may be embodied in one module or unit, or the features and functions of one module or unit described above may be further divided into a plurality of modules or units.

Other embodiments of the present disclosure will be apparent to those skilled in the art from consideration of the specification and practice of the present disclosure disclosed here. This application is intended to cover any variations, uses, or adaptations of the present disclosure following the general principles thereof and including the common sense and the commonly-used technology means in the related field not disclosed in the present disclosure. It is intended that the specification and embodiments be considered as exemplary only, with a scope of the present disclosure being indicated by the following claims.

It will be appreciated that the present disclosure is not limited to the exact construction that has been described above and illustrated in the accompanying drawings, and that various modifications and changes can be made without departing from the scope thereof. The scope of the present disclosure is only restricted by the appended claims.

What is claimed is:

1. A method of upgrading inverter software, comprising:
embedding a software upgrade package for software to be upgraded into an application package, and uploading the application package to a server;
obtaining the application package from the server through a terminal and sending the application package to an inverter, wherein the terminal and the inverter are connected through a wireless communication;
in an operating cycle, determining by the inverter whether current time is within a predetermined time window, and if the current time is within the predetermined time window, performing a next operation, and if the current time is not within the predetermined time window, entering a next operating cycle;
obtaining version information of the software of the inverter to be upgraded;
comparing the version information of the software of the inverter to be upgraded with version information of the software upgrade package in the application package; and
if a comparison result is that the version information of the software to be upgraded is lower than the version information of the software upgrade package in the application package, using the software upgrade package for the inverter to perform an upgrade operation.

2. The method of upgrading inverter software according to claim 1, wherein both the terminal and the inverter are equipped with a Bluetooth unit, and the wireless communication is a Bluetooth communication.

3. The method of upgrading inverter software according to claim 2, wherein the step of sending the application package to the inverter through the terminal comprises:
sending the application package to the inverter through the terminal by the Bluetooth communication.

4. The method of upgrading inverter software according to claim 1, further comprising:
when the application package is being sent to the inverter through the terminal, executing a prompt event by the terminal to inform the user to wait.

5. The method of upgrading inverter software according to claim 1, after obtaining the application package from the server through the terminal and sending the application package to the inverter, further comprising:
after the inverter obtains the software upgrade package, detecting integrity of the software upgrade package by the inverter, and when it confirms that the software upgrade package is complete, performing the upgrade operation by the inverter.

6. The method of upgrading inverter software according to claim 1, wherein the predetermined time window is a time period.

7. The method of upgrading inverter software according to claim 1, wherein the predetermined time window is a time when the inverter is in a grid synchronization state or a standby state.

8. The method of upgrading inverter software according to claim 1, wherein the inverter comprises an inverter system controller, the inverter system controller comprises a master controller and at least one slave controller, upgrade of the inverter comprises upgrade of the master controller or upgrade of any of the slave controllers, and the method of upgrading inverter software further comprises:
determining whether the version information of the software of all of the slave controllers to be upgraded in the inverter has been compared with the version information of the software upgrade package;
if not the version information of the software of all of the slave controllers to be upgraded in the inverter has been compared with the version information of the software upgrade package, going to a next slave controller to be upgraded in the inverter, and going to the step of obtaining the version information of the software of the said next slave controller to be upgraded in the inverter;
if the version information of the software of all of the slave controllers to be upgraded in the inverter has been compared with the version information of the software upgrade package, determining whether the software of all of the slave controllers in the inverter has been upgraded; and
if not the software of all of the slave controllers in the inverter has been upgraded, entering the next operating cycle; if the software of all of the slave controllers in the inverter has been upgraded, clearing the application package.

9. A system of upgrading inverter software, including a server, a terminal and an inverter, wherein the inverter is deployed with software to be upgraded, and wherein the server, configured to receive an application package and send the application package, wherein a software upgrade package for software to be upgraded is embedded into the application package;
the terminal, configured to obtain the application package from the server and send the application package; and
the inverter, configured to receive the application package sent by the terminal through a wireless communication, and, in an operating cycle, determine whether current time is within a predetermined time window, and if the current time is within the predetermined time window, perform a next operation, and if the current time is not within the predetermined time window, enter a next operating cycle; and further configured to obtain version information of the software of the inverter to be upgraded, and compare the version information of the software of the inverter to be upgraded with version information of the software upgrade package in the application package; and if a comparison result is that the version information of the software to be upgraded is lower than the version information of the software upgrade package in the application package, using the software upgrade package for the inverter to perform an upgrade operation.

10. The system of upgrading inverter software according to claim 9, wherein both the terminal and the inverter are equipped with a Bluetooth unit, and the wireless communication is a Bluetooth communication.

11. The system of upgrading inverter software according to claim 10, wherein, when the application package is being sent to the inverter through the terminal, a prompt event is executed by the terminal to inform the user to wait.

12. The system of upgrading inverter software according to claim 11, wherein, after the inverter obtains the software upgrade package, the inverter detects integrity of the software upgrade package, and only when it confirms that the software upgrade package is complete, the inverter performs the upgrade operation.

13. The system of upgrading inverter software according to claim 9, wherein the predetermined time window is a time period.

14. The system of upgrading inverter software according to claim 9, wherein the predetermined time window is a time when the inverter is in a grid synchronization state or a standby state.

15. The system of upgrading inverter software according to claim 9, wherein the inverter comprises an inverter system controller, the inverter system controller comprises a master controller and at least one slave controller, upgrade of the inverter comprises upgrade of the master controller or upgrade of any of the slave controllers, and the inverter is further configured to preform:
determining whether the version information of the software of all of the slave controllers to be upgraded in the inverter has been compared with the version information of the software upgrade package;
if not the version information of the software of all of the slave controllers to be upgraded in the inverter has been compared with the version information of the software upgrade package, going to a next slave controller to he upgraded in the inverter, and going to the operation of obtaining the version information of the software of the said next slave controller to be upgraded in the inverter;
if the version information of the software of all of the slave controllers to be upgraded in the inverter has been compared with the version information of the software upgrade package, determining whether the software of all of the slave controllers in the inverter has been upgraded; and
if not the software of all of the slave controllers in the inverter has been upgraded, entering the next operating cycle; if the software of all of the slave controllers in the inverter has been upgraded, clearing the application package.

16. The system of upgrading inverter software according to claim 15, wherein the master controller is connected with the slave controller through a wired communication, wherein the wired communication is RS485, UART, I2C or SPI.

17. An electronic device, embedded in the inverter in the system of upgrading inverter software according to claim 9, comprising:
the inverter system controller; and
a memory, configured to store executable instructions for the inverter system controller and the software upgrade package, wherein
the inverter system controller is configured to execute the executable instructions to cooperate with the inverter to perform the wireless communication.

18. The electronic device according to claim 17, wherein the inverter system controller is a microprocessor.
